(19) United States
(12) Patent Application Publication
(10) Pub. No.: US 2012/0183865 A1
(43) Pub. Date: Jul. 19, 2012

(54) NON-AQUEOUS ELECTROLYTE FOR SECONDARY BATTERIES AND NON-AQUEOUS ELECTROLYTE SECONDARY BATTERY

(76) Inventor: Masaki Deguchi, Hyogo (JP)

(21) Appl. No.: 13/499,563

(22) PCT Filed: Jun. 30, 2011
(86) PCT No.: PCT/JP2011/003760

§ 371 Date: Mar. 30, 2012

(30) Foreign Application Priority Data
Sep. 10, 2010 (JP) 2010203374

(51) Int. Cl. H01M 10/056

(52) U.S. Cl. 429/331

(57) ABSTRACT

The non-aqueous electrolyte for secondary batteries includes a non-aqueous solvent and a lithium salt dissolved in the non-aqueous solvent. The non-aqueous solvent includes a fluorine-containing cyclic carbonate, propylene carbonate, and diethyl carbonate. The content W_{FCC} of the fluorine-containing cyclic carbonate is 2 to 12 mass %, the content W_{PC} of the propylene carbonate is 40 to 70 mass %, and the content W_{DEC} of the diethyl carbonate is 20 to 50 mass % relative to the total of the non-aqueous solvent. The content of ethylene carbonate in the non-aqueous solvent may be 5 mass % or less.

### TECHNICAL FIELD

The present invention relates to a non-aqueous electrolyte for secondary batteries and a non-aqueous electrolyte secondary battery, and particularly relates to an improvement of a non-aqueous electrolyte including propylene carbonate (PC) and diethyl carbonate (DEC).

### BACKGROUND ART

In non-aqueous electrolyte secondary batteries which are represented by lithium-ion secondary batteries, a non-aqueous solvent solution of a lithium salt is used as the non-aqueous electrolyte. Examples of the non-aqueous solvent include cyclic carbonates such as ethylene carbonate (EC) and PC, and chain carbonates such as DEC. Generally, two or more carbonates are combined in many cases.

In Patent Literature 1, EC and PC are mixed in equal volumes. In Patent Literature 2, less than 5 volume % of a carbonate having a carbon-carbon double bond (vinylene carbonate etc.) is added to a non-aqueous solvent including 40 volume % or more of PC. In Example of Patent Literature 2, EC and PC are used in roughly equal volumes.

Patent Literature 3 discloses a non-aqueous electrolyte including 10 to 60 volume % of PC, 1 to 20 volume % of EC, and 30 to 85 volume % of a chain carbonate such as DEC, to which 1,3-propane sultone and vinylene carbonate are added.

### CITATION LIST

### Patent Literatures

[PTL 1] Japanese Laid-Open Patent Publication No. 2006-221935
[PTL 2] Japanese Laid-Open Patent Publication No. 2003-168477
[PTL 3] Japanese Laid-Open Patent Publication No. 2004-355974

### SUMMARY OF INVENTION

### Technical Problem

The non-aqueous electrolytes of Patent Literatures 1 and 2 have high viscosity because they include a large amount of EC and do not include DEC or include little amount of DEC, if any. When the non-aqueous electrolytes have high viscosity, they cannot easily permeate electrode plates; moreover, since the ion conductivity lowers, rate characteristics, particularly rate characteristics at low temperatures tend to lower.

Also, since EC undergoes easily oxidative decomposition and subsequent reductive decomposition, it produces a large amount of gas such as CO, CO₂, methane, and ethane. The oxidative decomposition of EC is particularly distinguishing when a lithium-containing transition metal oxide including nickel is used as the positive electrode active material.

Therefore, gas production caused by decomposition of EC cannot be neglected even when the content of EC is relatively low. In Patent Literatures 1 and 2, since the content of EC is high, the amount of gas produced from EC increases significantly when the battery is stored in a high-temperature environment or when the charge and discharge are repeated, resulting in a decrease in the charge and discharge capacity of the battery.

Further, although PC is not decomposed easily as compared with EC and DEC, when the content of PC is increased by reducing the proportion of EC and DEC, production of gas caused by reductive decomposition in the negative electrode cannot be negligible. The decomposition of PC in the negative electrode can be suppressed to some extent by using an additive such as vinylene carbonate. However, vinylene carbonate itself is likely to undergo oxidative decomposition in the positive electrode, whereby gas is produced.

### Solution to Problem

An object of the present invention is to provide a non-aqueous electrolyte for secondary batteries and a non-aqueous electrolyte secondary battery that can suppress remarkably gas production even when the battery is stored in a high-temperature environment, or when the charge and discharge are repeated.

Another object of the present invention is to provide a non-aqueous electrolyte for secondary batteries and a non-aqueous electrolyte secondary battery that can suppress the decline in the charge and discharge capacity caused by gas production and the decline in the rate characteristics at low temperatures.

An aspect of the present invention relates to a non-aqueous electrolyte for secondary batteries comprising a non-aqueous solvent and a lithium salt dissolved in the non-aqueous solvent, the non-aqueous solvent including a fluorine-containing cyclic carbonate, propylene carbonate, and diethyl carbonate, and a content W_{FCC} of the fluorine-containing cyclic carbonate being 2 to 12 mass %, a content W_{PC} of the propylene carbonate being 40 to 70 mass %, and a content W_{DEC} of the diethyl carbonate being 20 to 50 mass % relative to a total of the non-aqueous solvent.

Another aspect of the present invention relates to a non-aqueous electrolyte secondary battery comprising: a positive electrode; a negative electrode; a separator disposed between the positive electrode and the negative electrode; and the non-aqueous electrolyte for secondary batteries.

### Advantageous Effects of Invention

According to the present invention, gas production can be suppressed remarkably even when the non-aqueous electrolyte secondary battery is stored in a high-temperature environment, or even when the charge and discharge are repeated. Consequently, the decrease in the charge and discharge capacity caused by gas production can be suppressed. Also, since the decline in the ion conductivity of the non-aqueous electrolyte can be suppressed, the decline in the rate characteristics at low temperatures can be suppressed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A schematic vertical sectional view of an example of the non-aqueous electrolyte secondary battery in accordance with the present invention.

### DESCRIPTION OF EMBODIMENT

### Non-Aqueous Electrolyte

A non-aqueous electrolyte for secondary batteries includes a non-aqueous solvent and a lithium salt dissolved in the non-aqueous solvent. In the present invention, the non-aqueous solvent includes a fluorine-containing cyclic carbonate, PC, and DEC. Examples of the fluorine-containing cyclic carbonate include fluorine-containing cyclic carbonates having 1 to 6 fluorine atoms such as monofluoroethylene carbonate (FEC), 1,2-difluoroethylene carbonate, 1,2,3-trifluoropropylene carbonate, 2,3-difluoro-2,3-butylene carbonate, and 1,1,1,4,4,4-hexafluoro-2,3-butylene carbonate. The fluorine-containing cyclic carbonate is preferably a 5 to 8-membered, more preferably 5 to 7-membered fluorine-containing cyclic carbonate.

In view of the viscosity and the solubility of the lithium salt, the fluorine-containing cyclic carbonate preferably includes monofluoroethylene carbonate (FEC). The content of FEC in the fluorine-containing cyclic carbonate is, for example, 80 mass % or more, preferably 90 mass % or more.

The content of each solvent is: the content W_{FCC} of the fluorine-containing cyclic carbonate is 2 to 12 mass %, the content W_{PC} of PC is 40 to 70 mass %, and the content W_{DEC} of DEC is 20 to 50 mass %, respectively, relative to the total of the non-aqueous solvent.

In the present invention, the fluorine-containing cyclic carbonate is used in place of EC that is used frequently as the non-aqueous solvent. The fluorine-containing cyclic carbonate has higher oxidation resistance than EC. Therefore, by using the fluorine-containing cyclic carbonate, gas production caused by oxidative decomposition and subsequent reductive decomposition, which occurs when EC is used, can be prevented.

Although the non-aqueous solvent may include EC, the EC content in the non-aqueous solvent is, for example, 5 mass % or less (0 to 5 mass %), preferably 0.1 to 3 mass %, more preferably 0.5 to 2 mass % for reducing the amount of gas production.

The fluorine-containing cyclic carbonate forms easily a solid electrolyte layer (SEI: Solid Electrolyte Interphase) or a protective coating film at high reduction potential in the negative electrode as compared with EC or vinylene carbonate. Therefore, reductive decomposition of PC in the negative electrode can be suppressed by adding the fluorine-containing cyclic carbonate even when the amount of the additive capable of forming a coating film in the negative electrode such as vinylene carbonate is small. Therefore, production of reductive decomposition gas (methane, ethane, propene, propane etc.) originating from PC can be suppressed remarkably although the content of PC in the non-aqueous solvent is high as describe above. Also, since the content of DEC that is decomposed more easily than PC can be relatively low because the content of PC can be high, the amount of gas (CO, CO₂, methane, ethane etc.) produced by oxidative decomposition and reductive decomposition of DEC can be reduced.

The content W_{FCC} of the fluorine-containing cyclic carbonate is preferably 5 to 10 mass %, more preferably 7 to 10 mass %. The content W_{PC} of PC is preferably 50 to 70 mass %, more preferably 50 to 60 mass %. The content W_{DEC} of DEC is preferably 25 to 45 mass %, more preferably 30 to 40 mass %.

When the content of the fluorine-containing cyclic carbonate is too low, the content of PC and DEC is relatively high, and also, it is not possible to suppress sufficiently reductive decomposition of PC, which makes it difficult to suppress sufficiently gas production. When the content of the fluorine-containing cyclic carbonate is too high, the reductive protective coating film originating from the fluorine-containing cyclic carbonate in the negative electrode becomes thick, and the coating film resistance is increased to prevent insertion or elimination reaction of lithium ions, which may lower the charge and discharge characteristics.

When the content of DEC is too low, the non-aqueous electrolyte tends to have high viscosity and have difficulty in permeating the electrode plates; in addition, the ion conductivity decreases to lower the rate characteristics at low temperatures. When the content of DEC is too high, gas production caused by oxidative decomposition and reductive decomposition of DEC becomes significant.

In view of maintaining the rate characteristics at low temperatures, the viscosity of the non-aqueous electrolyte at 25° C. is, for example, 3 to 6.5 mPa·s, preferably 4.5 to 6 mPa·s. The viscosity can be measured, for example, with a rotational viscometer by using a spindle of cone-plate type.

The non-aqueous solvent may include, as necessary, other solvents than the aforementioned three solvents. Examples of these other solvents include chain carbonic esters other than DEC (ethyl methyl carbonate (EMC), dimethyl carbonate (DMC) etc.); and cyclic carboxylic esters such as γ-butyrolactone (GBL) and γ-valerolactone (GVL). These other non-aqueous solvents may be used singly or in combination of two or more. The content of the other non-aqueous solvents is, for example, 5 mass % or less (0 to 5 mass %), preferably 0.1 to 3 mass % relative to the total of the non-aqueous solvent.

The non-aqueous electrolyte may include, as necessary, a known additive such as a cyclic carbonic ester having a C═C bond, a sultone compound, cyclohexylbenzene, and diphenyl ether. The cyclic carbonic ester having a C═C bond and the sultone compound are capable of forming a coating film in the positive electrode and/or the negative electrode. In the present invention, since the fluorine-containing cyclic carbonate is used, an SEI or a protective coating film is formed in the negative electrode, and decomposition of the non-aqueous solvent can be prevented effectively even when the additive capable of forming a coating film is not particularly used; however, the use of the above additive is not denied.

Examples of the cyclic carbonic esters having a C═C bond include unsaturated cyclic carbonic esters such as vinylene carbonate; and cyclic carbonic esters having a C₂₋₄ alkenyl group such as vinylethylene carbonate and divinylethylene carbonate. Examples of the sultone compound include C₃₋₄ alkanesultone such as 1,3-propanesultone, and C₃₋₄ alkenesultone such as 1,3-propenesultone.

The additive may be used singly or in combination of two or more. The content of the additive is, for example, 10 mass % or less, preferably 0.1 to 5 mass % relative to the total of the non-aqueous electrolyte.

Examples of the lithium salt include lithium salt of fluorine-containing acid (LiPF₆, LiBF₄, LiCF SO₃ etc.), and lithium salt of fluorine-containing acid imide (LiN(CF₃SO₂)₂ etc.). The lithium salt may be used singly or in combination of two or more. The concentration of the lithium salt in the non-aqueous electrolyte is, for example, 0.5 to 2 mol/L.

The non-aqueous electrolyte can be prepared by a conventional method, for example, by mixing the non-aqueous solvent and the lithium salt to dissolve the lithium salt in the non-aqueous solvent. The order of mixing each solvent and each component is not particularly limited. For example, after the non-aqueous solvent is mixed beforehand, the lithium salt may be added and dissolved. Alternatively, the lithium salt may be dissolved in a part of the non-aqueous solvent, and subsequently the remaining non-aqueous solvent may be mixed therewith.

The non-aqueous electrolyte as above can suppress reaction of the non-aqueous solvent included in the non-aqueous electrolyte with the positive electrode and/or the negative electrode and can remarkably suppress gas production, thereby to prevent the decline in the charge and discharge capacity. Also, since the non-aqueous electrolyte has low viscosity, it can ensure high ion conductivity even at low temperatures, permitting suppression of the decline in the rate characteristics. Therefore, it can be used advantageously in non-aqueous electrolyte secondary batteries such as lithium-ion secondary batteries.

### (Non-Aqueous Electrolyte Secondary Battery)

A non-aqueous electrolyte secondary battery in accordance with the present invention comprises a positive electrode, a negative electrode, and a separator disposed between the positive electrode and the negative electrode together with the aforementioned non-aqueous electrolyte.

### (Positive Electrode)

The positive electrode includes a positive electrode active material such as a lithium-containing transition metal oxide. The positive electrode usually includes a positive electrode current collector and a positive electrode active material layer adhered to a surface of the positive electrode current collector. The positive electrode current collector may be a nonporous conductive substrate (metal foil, metal sheet etc.) or may be a porous conductive substrate having a plurality of through holes (punching sheet, expanded metal etc.).

Examples of metal material used for the positive electrode current collector include stainless steel, titanium, aluminum, and aluminum alloy.

In view of the strength and lightness of the positive electrode, the thickness of the positive electrode current collector is, for example, 3 to 50 μm, preferably 5 to 30 μm.

The positive electrode active material layer may be formed on one surface or both surfaces of the positive electrode current collector. The positive electrode active material layer includes a positive electrode active material and a binder. The positive electrode active material layer may further include, as necessary, a thickener, a conductive material and the like.

Examples of the positive electrode active material include a transition metal oxide commonly used in the field of the non-aqueous electrolyte secondary batteries, for example, a lithium-containing transition metal oxide.

Examples of transition metal elements include Co, Ni, and Mn. These transition metals may be partly replaced by a different element. Examples of the different element include at least one selected from Na, Mg, Sc, Y, Cu, Fe, Zn, Al, Cr, Pb, Sb, and B. The positive electrode active material may be used singly or in combination of two or more.

Specific examples of the positive electrode active material include LiₓNi_{y}MₓMe_{1-(y+z)}O_{2+d}, LiₓM_{y}Me_{1-y}O_{2+d}, and LiₓMn₂O₄.

M is at least one element selected from the group consisting of Co and Mn. Me is the above different element and is preferably at least one selected from the group consisting of Al, Cr, Fe, Mg, and Zn.

In the above formula, x safisfies 0.98≦x≦1.2, y satisfies 0.3≦y≦1, and z safisfies 0≦z≦0.7.

Herein, y+x satisfies 0.9≦(y+z)≦1, preferably 0.93≦(y+z)≦0.99. d satisfies −0.01≦d≦0.01.

In the above formula, x satisfies preferably 0.99≦x≦1.1. y preferably satisfies 0.7≦y≦0.9 (particularly 0.75≦y≦0.85), and z preferably satisfies 0.05≦z≦0.4 (particularly 0.1≦z≦0.25). Also, y preferably satisfies 0.25≦y≦0.5 (particularly 0.3≦y≦0.4), and z preferably satisfies 0.5≦z≦0.75 (particularly 0.6≦z≦0.7). In the latter case, the element M may be a combination of Co and Mn, and a molar ratio Co/Mn of Co with Mn may satisfy 0.2≦Co/Mn≦4, preferably 0.5≦Co/Mn≦2, more preferably 0.8≦Co/Mn≦1.2.

In the present invention, since EC is not included or included in a small amount, if any, gas production can be reduced greatly even when a lithium-containing transition metal oxide including Ni that decomposes easily EC is used. Such a lithium-containing transition metal oxide corresponds to LiₓNi_{y}M_{z}Me_{1-(y+z)}O_{2+d} among the aforementioned positive electrode active materials. The lithium-containing transition metal oxide including Ni is advantageous in the point of having a high capacity.

Examples of the binder include fluorocarbon resins such as polytetrafluoroethylene (PTFE), polyvinylidene fluoride (PVDF), vinylidene fluoride (VDF)-hexafluoropropylene (HFP) copolymer; polyolefin resins such as polyethylene and polypropylene, polyamide resins such as aramid; polyimide resins such as polyimide and polyamide imide; acrylic resins such as polymethyl acrylate and ethylene-methyl methacrylate copolymer; vinyl resins such as polyvinyl acetate and ethylene-vinyl acetate copolymer; polyether sulfone; polyvinyl pyrrolidone; and rubber materials such as acrylic rubber. The binder may be used singly or in combination of two or more.

The proportion of the binder is, for example, 0.1 to 20 mass parts, preferably 1 to 10 mass parts relative to 100 mass parts of the positive electrode active material.

Examples of the conductive material include carbon black; conductive fiber such as carbon fiber and metal fiber; carbon fluoride; and natural or artificial graphite. The conductive material may be used singly or in combination of two or more.

The proportion of the conductive material is, for example, 0 to 15 mass parts, preferably 1 to 10 mass parts relative to 100 mass parts of the positive electrode active material.

Examples of the thickener include cellulose derivatives such as carboxymethyl cellulose (CMC), polyC₂₋₄ alkylene glycol such as polyethylene glycol and ethylene oxide-propylene oxide copolymer; polyvinyl alcohol; and solubilized modified rubber. The thickener may be used singly or in combination of two or more.

The proportion of the thickener is not particularly limited and is, for example, 0 to 10 mass parts, preferably 0.01 to 5 mass parts relative to 100 mass parts of the positive electrode active material.

The positive electrode can be formed by preparing a positive electrode slurry including the positive electrode active material and the binder and applying the same onto a surface of the positive electrode current collector. The positive electrode slurry includes usually a dispersing medium, and as necessary, a conductive material and further a thickener may be added thereto.

Examples of the dispersing medium include, although not particularly limited, water, alcohol such as ethanol, ether such as tetrahydrofuran, amide such as dimethylformamide, N-methyl-2-pyrrolidone (NMP), and mixed solvent thereof.

The positive electrode slurry can be prepared by a method using a conventional mixer or kneader. The positive electrode slurry can be applied onto a surface of the positive electrode current collector by a conventional coating method, for example, by a coating method using various coaters such as die coater, blade coater, knife coater, and gravure coater.

The coating film of the positive electrode slurry formed on the surface of the positive electrode current collector is usually dried and rolled. The drying may be air drying or drying by heating or under reduced pressure. When rolling is performed by rollers, the pressure is a linear pressure of, for example, 1 to 30 kN/cm.

The thickness of the positive electrode active material layer (or positive electrode material mixture layer) is, for example, 30 to 100 μm, preferably 50 to 70 μm.

### (Negative Electrode)

The negative electrode includes a negative electrode current collector and a negative electrode active material layer adhered to the negative electrode current collector. Examples of the negative electrode current collector include nonporous or porous conductive substrate as mentioned in the positive electrode current collector. Examples of metal material forming the negative electrode current collector include stainless steel, nickel, copper, copper alloy, aluminum, and aluminum alloy. Among these materials, copper or copper alloy is preferable.

As the negative electrode current collector, a copper foil, particularly an electrolytic copper foil is preferable. The copper foil may include 0.2 mol % or less of components other than copper.

The thickness of the negative electrode current collector can be selected, for example, from a range of 3 to 50 μm, preferably 5 to 30 μm.

The negative electrode active material layer includes a negative electrode active material as an essential component and may include a binder, a conductive material and/or a thickener as optional components. When the binder is used, the binder binds the particles of the negative electrode active material in the negative electrode active material layer. The negative electrode active material layer may be formed on one surface or both surfaces of the negative electrode current collector.

The negative electrode may be a deposited film by a gas phase method or may be a material mixture layer including a negative electrode active material, a binder, and as necessary, a conductive material and/or a thickener.

The deposited film can be formed by depositing the negative electrode active material on a surface of the negative electrode current collector by a gas phase method such as vacuum deposition method, sputtering method, and ion plating method. In this case, as the negative electrode active material, silicon, silicon compound, lithium alloy and the like as described later can be used.

Also, the material mixture layer can be formed by preparing a negative electrode slurry including a negative electrode active material, a binder, and as necessary, a conductive material and/or a thickener, and applying the same onto a surface of the negative electrode current collector. The negative electrode slurry includes usually a dispersing medium. The thickener and/or the conductive material are/is usually added to the negative electrode slurry. The negative electrode slurry can be prepared according to the preparation method of the positive electrode slurry. The application of the negative electrode slurry can be performed by a method similar to the application method of the positive electrode.

Examples of the negative electrode active material include carbon material; silicon and silicon compound; and lithium alloy including at least one selected from tin, aluminum, zinc, and magnesium.

Examples of the carbon material include graphite (natural graphite, artificial graphite, graphitized mesophase carbon etc.), coke, partially graphitized carbon, graphitized carbon fiber, and amorphous carbon. The amorphous carbon includes, for example, graphitizable carbon material (soft carbon) that is easily graphitized by a heat treatment at high temperatures (2800° C., for example) and non-graphitizable carbon material (hard carbon) that is hardly graphitized by the above heat treatment. The soft carbon has a structure in which microcrystallites such as graphite are aligned in almost the same direction, and the hard carbon has a tubostratic structure.

Examples of the silicon compound include a silicon oxide SiOα (0.05<α<1.95). α is preferably 0.1 to 1.8, more preferably 0.15 to 1.6. In the silicon oxide, a part of the silicon may be replaced by one or more elements. Examples of such elements include B, Mg, Ni, Co, Ca, Fe, Mn, Zn, C, N, and Sn.

Among the negative electrode active materials, graphite particles are preferable. In view of suppressing more effectively reductive decomposition of the non-aqueous solvent in the negative electrode, graphite particles coated with a water-soluble polymer may be used as the negative electrode active material, as necessary.

A diffraction image of graphite particles measured by a wide-angle X-ray diffraction method has a peak attributed to a (101) face and a peak attributed to a (100) face. Herein, a ratio of an intensity I(101) attributed to the (101) face and an intensity I(100) attributed to the (100) face satisfies preferably 0.01<I(101)/I(100)<0.25, more preferably 0.08<I(101)/I(100)<0.20. Herein, the intensity of the peak means the height of the peak.

The graphite particles have an average particle diameter of, for example, 5 to 25 μm, preferably 10 to 25 μm, more preferably 14 to 23 μm. When the average particle diameter falls within the above range, the graphite particles in the negative electrode active material layer have improved slipping properties and the graphite particles are in better filling condition, which is advantageous in improving the adhesive strength between the graphite particles. Herein, the average particle diameter means a median diameter (D50) in the volumetric particle size distribution of the graphite particles. The volumetric particle size distribution of the graphite particles can be measured, for example, by a commercially available particle size distribution measuring device of a laser diffraction type.

The graphite particles have an average circularity of preferably 0.90 to 0.95, more preferably 0.91 to 0.94. When the average circularly falls within the above range, the graphite particles in the negative electrode active material layer have improved slipping properties, which is advantageous in improving the filling condition of the graphite particles and improving the adhesive strength between the graphite particles. Herein, the average circularity is represented by 4 nS/L² (S represents area of orthographic image of graphite particles, L represents circumference of orthographic image). For example, it is desirable that the average circularity of arbitrary selected 100 graphite particles falls within the above range.

The graphite particles have a specific surface area S of preferably 3 to 5 m²/g, more preferably 3.5 to 4.5 m²/g. When the specific surface area falls within the above range, the graphite particles in the negative electrode active material layer have improved slipping properties, which is advantageous in improving the adhesive strength between the graphite particles. Also, the appropriate amount of the water-soluble polymer coating surfaces of the graphite particles can be decreased.

Examples of the water-soluble polymer include, although not particularly limited thereto, cellulose derivatives; polyacrylic acid, polyvinyl alcohol, polyvinyl pyrrolidone, or derivatives thereof. Among these polymers, cellulose derivatives and polyacrylic acid are particularly preferable. Preferable cellulose derivatives include methyl cellulose, carboxymethyl cellulose, and Na salt of carboxymethyl cellulose. The cellulose derivatives have preferably a molecular weight of 10,000 to 1,000,000. The polyacrylic acid has preferably a molecular weight of 5,000 to 1,000,000.

The amount of the water-soluble polymer included in the negative electrode active material layer is, for example, 0.5 to 2.5 mass parts, preferably 0.5 to 1.5 mass parts, more preferably 0.5 to 1.0 mass parts relative to 100 mass parts of the graphite particles. When the amount of the water-soluble polymer falls within the above range, the water-soluble polymer can coat the surfaces of the graphite particles at a high coating rate. Also, since the surfaces of the graphite particles are not coated excessively with the water-soluble polymer, the increase in the internal resistance of the negative electrode can be suppressed.

The coating of the graphite particles can be performed, for example, by mixing the graphite particles together with water and the water-soluble polymer dissolved in water, and drying the resulting mixture. For example, the water-soluble polymer is dissolved in water to prepare an aqueous solution. The obtained aqueous solution is mixed with the graphite particles, and subsequently water is removed and the mixture is dried. Thus, by drying the mixture once, the water-soluble polymer is adhered effectively to the surfaces of the graphite particles, which increases the coating rate of the surfaces of the graphite particles by the water-soluble polymer.

The surfaces of the graphite particles may be coated by being treated with the water-soluble polymer prior to the preparation of the negative electrode slurry. Alternatively, the surfaces of the graphite particles may be coated with the water-soluble polymer by adding the water-soluble polymer in the process of preparing the negative electrode slurry.

It is preferable that the viscosity of the aqueous solution of the water-soluble polymer is controlled to 1 to 10 Pa·s at 25° C. The viscosity is measured by using a B type viscometer and using a spindle of 5 mmΦ at a peripheral velocity of 20 mm/s. Also, the amount of the graphite particles mixed with 100 mass parts of the aqueous solution of the water-soluble polymer is preferably 50 to 150 mass parts.

The drying temperature of the mixture is preferably 80 to 150° C., and the drying time is preferably 1 to 8 hours.

Next, the negative electrode slurry is prepared by mixing the mixture obtained by drying, the binder, and the dispersing medium. Through this process, the binder is adhered to the surfaces of the graphite particles coated with the water-soluble polymer. Since the slipping properties between the graphite particles are favorable, the binder adhered to the surfaces of the graphite particles receives a sufficient shearing force and acts effectively on the surfaces of the graphite particles.

When the graphite particles are mixed with the water-soluble polymer, the same solvent as the dispersing medium (NMP etc.) may be used as necessary, and alcohol (water-soluble alcohol such as methanol and ethanol), a mixed solvent of these solvents with water and the like may be used.

As the binder, the dispersing medium, the conductive material, and the thickener, ones similar to those mentioned in the paragraph of the positive electrode slurry can be used. In the negative electrode slurry, among the components indicated as the conductive materials, materials other than graphite are often used.

As the binder, one having a particle form and having rubber elasticity is preferable. As such a binder, a polymer having a styrene unit and a butadiene unit is preferable. Such a polymer has excellent elasticity and is stable in the negative electrode potential.

The binder having a particle form has an average particle diameter of, for example, 0.1 μm to 0.3 μm, preferably 0.1 μm to 0.25 μm, more preferably 0.1 μm to 0.15 μm. The average particle diameter of the binder can be obtained, for example, by taking SEM photographs of 10 binder particles with a transmission electron microscope (available from Japan Electronic Co, Ltd., accelerating voltage 200 kV) and determining an average value of maximum diameters of these binder particles.

The proportion of the binder can be selected from a range of, for example, 0.1 to 10 mass parts relative to 100 mass parts of the negative electrode active material (graphite particles etc.). When the surfaces of the graphite particles are coated with the water-soluble polymer, the proportion of the binder is, for example, 0.4 to 1.5 mass parts, preferably 0.4 to 1 mass part relative to 100 mass parts of the graphite particles. Since the slipping properties between the graphite particles are improved when the surfaces of the graphite particles are coated with the water-soluble polymer, the binder adhered to the surfaces of the graphite particles receives a sufficient shearing force and acts effectively on the surfaces of the graphite particles. Also, the binder having a particle form and having a small average particle diameter has a high probability of contacting the surfaces of the graphite particles. Therefore, sufficient binding properties are exhibited even when the amount of the binder is small.

The negative electrode can be produced according to the production method of the positive electrode. Specifically, for example, it can be formed by applying the negative electrode slurry prepared as above onto the surface of the negative electrode current collector. The coating film formed on the surface of the negative electrode current collector is usually dried and rolled.

The drying method and the rolling conditions (linear pressure etc.) of the coating film are similar to those in the case of the positive electrode.

The proportion of the conductive material is not particularly limited and is, for example, 0 to 5 mass parts, preferably 0.01 to 3 mass parts relative to 100 mass parts of the negative electrode active material. The proportion of the thickener is not particularly limited and is, for example, 0 to 10 mass parts, preferably 0.01 to 5 mass parts relative to 100 mass parts of the negative electrode active material.

The thickness of the negative electrode active material layer (or negative electrode material mixture layer) is, for example, 30 to 110 μm, preferably 50 to 90 μm.

### (Separator)

Examples of the separator include a resin porous film (porous film) and nonwoven cloth. Examples of the resin forming the separator include polyolefin resins such as polyethylene, polypropylene, and ethylene-propylene copolymer. The porous film may include inorganic oxide particles as necessary.

The thickness of the separator is, for example, 5 to 100 μm, preferably 7 to 50 μm.

### (Others)

The shape of the non-aqueous electrolyte secondary battery is not particularly limited and may be cylindrical shape, flat shape, coin shape, prismatic shape etc.

The non-aqueous electrolyte secondary battery can be produced by a conventional method according to the shape of the battery. The cylindrical battery or prismatic battery can be produced, for example, by winding the positive electrode, the negative electrode, and the separator separating the positive electrode and the negative electrode to form an electrode group, and housing the electrode group and the non-aqueous electrolyte in the battery case.

The electrode group is not limited to a wound type and may be a laminated type or a zigzag type. The shape of the electrode group may be, according to the shape of the battery or the battery case, a cylindrical shape, or a flat shape in which an end face perpendicular to the winding axis has an oval shape.

Although the battery case may be made of a laminate film, it is usually made of metal in view of pressure resistance. As the material for the battery case, aluminum, aluminum alloy (alloy including a small amount of metal such as manganese and copper), a steel plate etc. can be used.

### EXAMPLES

The present invention will be described specifically with reference to Examples and Comparative Examples. However, the present invention is not limited to the following Examples.

### Example 1

### (a) Production of Negative Electrode

### Step (i)

Sodium salt of carboxymethyl cellulose (CMC-Na salt, hereinafter, molecular weight: 400,000) as the water-soluble polymer was dissolved in water to give an aqueous solution having a CMC-Na salt concentration of 1.0 mass %. 100 mass parts of natural graphite particles (average particle diameter: 20 μm, average circularity: 0.92, specific surface area: 4.2 m²/g) and 100 mass parts of the CMC-Na salt aqueous solution were mixed and stirred while the temperature of the mixture was controlled at 25° C. Subsequently, the mixture was dried at 120° C. for 5 hours to give a dry mixture. In the dry mixture, the amount of the CMC-Na salt was 1.0 mass part relative to 100 mass parts of the graphite particles.

### Step (ii)

One hundred one mass parts of the obtained dry mixture, 0.6 mass part of a binder with rubber elasticity (SBR, hereinafter) being in a form of particles with an average particle diameter of 0.12 μm and including a styrene unit and a butadiene unit, 0.9 mass part of the CMC-Na salt, and an appropriate amount of water, were mixed to prepare a negative electrode slurry. Herein, SBR was mixed with the other components in the state of an emulsion containing water as the dispersing medium (BM-400B (trade name) available from Zeon Corporation, SBR content: 40 mass %).

Step (iii)

The obtained negative electrode slurry was applied onto both surfaces of an electrolytic copper foil (thickness 12 μm) as the negative electrode core material by using a die coater, and the coating film was dried at 120° C. Subsequently, the dry coating film was rolled with rollers with a linear pressure of 0.25 ton/cm, thereby to form a negative electrode active material layer having a graphite density of 1.5 g/cm³. The thickness of the entire negative electrode was 140 μm. The negative electrode active material layer was cut into a predetermined shape with the negative electrode core material, thereby producing a negative electrode.

### (b) Production of Positive Electrode

Four mass parts of PVDF as the binder was added to 100 mass parts of LiNi_{0.80}Co_{0.15}Al_{0.05}O₂ as the positive electrode active material, to which an appropriate amount of NMP was added and mixed, thereby to prepare a positive electrode slurry. The obtained positive electrode slurry was applied onto both surfaces of an aluminum foil having a thickness of 20 μm as the positive electrode core material by using a die coater, and the coating film was dried and subsequently rolled to form a positive electrode active material layer. The positive electrode active material layer was cut into a predetermined shape together with the positive electrode core material, thereby to produce a positive electrode.

### (c) Preparation of Non-Aqueous Electrolyte

LiPF₆ was dissolved at a concentration of 1 mol/L in a mixed solvent including FEC, PC, and DEC in a mass ratio W_{FEC}:W_{PC}:W_{DEC}=1:5:4, thereby to prepare a non-aqueous electrolyte. The viscosity of the non-aqueous electrolyte was measured with a rotational viscometer and found to be 5.4 mPa·s at 25° C.

### (d) Assembly of Battery

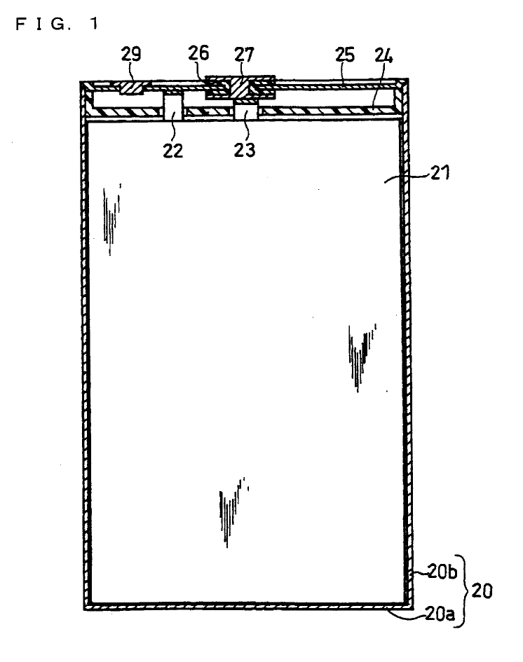

A prismatic lithium ion secondary battery as illustrated in FIG. 1 was produced.

The negative electrode and the positive electrode were wound with a separator composed of a microporous film made of polyethylene having a thickness of 20 μm (A089 (trade name) available from Celgard Co., Ltd.) disposed therebetween to form an electrode group 21 having a lateral cross section of roughly an oval shape. The electrode group 21 was housed in a battery can 20 of a prismatic shape made of aluminum. The battery can 20 has a bottom portion 20a and a side wall 20b, an open upper portion, and roughly a rectangular shape. The thickness of the main flat portion of the side wall was set to 80 μm.

Subsequently, an insulator 24 for preventing short-circuit between the battery can 20 and a positive lead 22 or a negative lead 23 was disposed on an upper portion of the electrode group 21. Next, a rectangular sealing plate 25 having a negative terminal 27 surrounded by an insulating gasket 26 in the center was disposed on the opening of the battery can 20. The negative lead 23 was connected with the negative terminal 27. The positive lead 22 was connected with a lower surface of the sealing plate 25. The end portion of the opening was laser welded to the sealing plate 25, thereby to seal the opening of the battery can 20. Subsequently, 2.5 g of the non-aqueous electrolyte was injected into the battery can 20 through an injection hole of the sealing plate 25. Finally, the injection hole was closed with a sealing plug 29 by welding, thereby to complete a prismatic lithium ion secondary battery 1 having a height of 50 mm, width of 34 mm, thickness of the inner space of about 5.2 mm, and design capacity of 850 mAh.

### <Evaluation of Battery>

### (i) Evaluation of Cycle Capacity Retention Rate

The battery 1 was subjected repeatedly to a charge and discharge cycle at 45° C. In the charge and discharge cycle, in the charge process, a constant current charge was performed at a current of 600 mA until the charge voltage reached 4.2 V, and then a constant voltage charge was performed at a voltage of 4.2 V until the current reached 43 mA. The rest time after the charge was set to 10 minutes. Meanwhile, in the discharge process, a constant current discharge was performed at a current of 850 mA until the discharge voltage reached 2.5 V. The rest time after the discharge was set to 10 minutes.

The discharge capacity at the 3^{rd} cycle was defined as 100%, and on the basis of this discharge capacity, the proportion of the discharge capacity after 500 cycles was represented by percentage, which was defined as the cycle capacity retention rate [%].

### (ii) Evaluation of Battery Expansion

The thickness of the central portion perpendicular to the maximum plane surface (length: 50 mm, width: 34 mm) of the battery 1 was measured in the state after the charge of the 3^{rd} cycle and in the state after the charge of the 501^{st} cycle. From the difference of these battery thicknesses, the amount of battery expansion [mm] after the charge and discharge cycle at 45° C. was determined.

(iii) Evaluation of Low-Temperature Discharge Characteristics

The battery 1 was subjected to 3 cycles of the charge and discharge cycle at 25° C. Next, after the charge process of the 4^{th} cycle was performed at 25° C., the battery was left at 0° C. for 3 hours, and then the discharge process was performed at 0° C. The discharge capacity at the 3^{rd} cycle (25° C.) was defined as 100%, and on the basis of this discharge capacity, the proportion of the discharge capacity at the 4^{th} cycle (0° C.) was represented by percentage, which was defined as the low-temperature discharge capacity retention rate [%]. The charge and discharge conditions were the same as Evaluation (i) except for the temperature and the rest time after the charge.

### Example 2

The non-aqueous electrolyte was prepared in the same manner as in Example 1 except that the ratio W_{FEC}:W_{PC}:W_{DEC} was changed as Table 1. Batteries 2 to 17 were produced in the same manner as in Example 1 except for using the obtained non-aqueous electrolyte.

Also, the non-aqueous electrolyte was prepared in the same manner as in Example 1 except for changing the ratio W_{FEC}:W_{PC}:W_{DEC} was changed as Table 1 and adding 5 mass % of EC, and by using this non-aqueous electrolyte, a battery 18 was produced in the same manner as in Example 1.

It is to be noted that batteries 14 to 17 are all batteries of Comparative Examples.

The batteries 2 to 18 were evaluated in the same manner as in Example 1.

The results of the batteries 1 to 18 are shown in Table 1.

TABLE 1

| | | | | | Battery | Low-temperature |
|---|---|---|---|---|---|---|
| | | | | Cycle capacity | expansion after | discharge capacity |
| | | | Viscosity | retention rate | cycle | retention rate |
| | W_{FEC}:W_{PC}:W_{DEC} | W_{EC} | (mPa · s) | (%) | (mm) | (%) |
| Battery 1 | 10:50:40 | 0 | 5.4 | 88.3 | 0.24 | 75.5 |
| Battery 2 | 5:55:40 | 0 | 5.5 | 85.7 | 0.33 | 74.2 |
| Battery 3 | 2:58:40 | 0 | 5.6 | 80.3 | 0.57 | 70.9 |
| Battery 4 | 12:48:40 | 0 | 5.4 | 85.8 | 0.34 | 70.3 |
| Battery 5 | 10:60:30 | 0 | 5.9 | 85.9 | 0.37 | 73.8 |
| Battery 6 | 10:65:25 | 0 | 6.3 | 82.0 | 0.46 | 72.1 |
| Battery 7 | 10:70:20 | 0 | 6.7 | 80.2 | 0.58 | 70.5 |
| Battery 8 | 10:45:45 | 0 | 5.2 | 86.6 | 0.27 | 76.2 |
| Battery 9 | 10:40:50 | 0 | 5.0 | 86.5 | 0.27 | 76.7 |
| Battery 10 | 5:60:35 | 0 | 5.5 | 85.1 | 0.36 | 74.0 |
| Battery 11 | 5:65:30 | 0 | 6.0 | 83.6 | 0.40 | 73.8 |
| Battery 12 | 5:50:45 | 0 | 4.9 | 86.4 | 0.28 | 76.4 |
| Battery 13 | 5:45:50 | 0 | 4.7 | 86.1 | 0.29 | 78.0 |
| Battery 14 | 1:59:40 | 0 | 5.6 | 57.7 | 1.04 | 66.8 |
| Battery 15 | 14:46:40 | 0 | 5.3 | 68.5 | 0.89 | 54.2 |
| Battery 16 | 10:75:15 | 0 | 7.2 | 67.0 | 0.92 | 53.0 |
| Battery 17 | 10:35:55 | 0 | 4.6 | 69.4 | 0.81 | 79.2 |
| Battery 18 | 5:50:40 | 5 | 5.4 | 81.5 | 0.51 | 74.3 |

From Table 1, it was found that all the batteries using the non-aqueous electrolyte including FEC, PC, and DEC with a specific content had a favorable cycle capacity retention rate and a low-temperature discharge capacity retention rate. Also, it was found that these batteries had small battery expansion after cycle and had a smaller amount of gas production.

It was found that the batteries 14 to 17 of Comparative Examples had considerable battery expansion and produced a large amount of gas. Also, these batteries had lower cycle capacity retention rate.

### Example 3

Batteries 36 to 39 were produced in the same manner as in Example 1 except for using those shown in Table 2 were used as the water-soluble polymer. All the water-soluble polymers used had a molecular weight of about 400,000.

Batteries 19 to 22 were evaluated in the same manner as in Example 1. The results are shown in Table 2.

TABLE 2

| | | | | Low- |
|---|---|---|---|---|
| | | | | temperature |
| | | Cycle | Battery | discharge |
| | | capacity | expansion | capacity |
| | Water- | retention | after | retention |
| | soluble | rate | cycle | rate |
| | polymer | (%) | (mm) | (%) |
| Battery 19 | CMC-Na salt | 88.3 | 0.24 | 75.5 |
| Battery 20 | CMC | 85.1 | 0.35 | 74.2 |
| Battery 21 | Methyl | 83.8 | 0.40 | 73.6 |
| | cellulose | | | |
| Battery 22 | Polyacrylic | 88.0 | 0.25 | 75.4 |
| | acid | | | |

From Table 2, all the batteries in which the surfaces of the graphite particles constituting the negative electrode were coated with the water-soluble polymer had favorable cycle capacity retention rate and low-temperature discharge capacity retention rate. Also, these batteries had small battery expansion after cycle.

### Example 4

Batteries 23 to 37 were produced in the same manner as in Example 1 except for using those shown in Table 3 were used as the positive electrode active material.

The batteries 23 to 37 were evaluated in the same manner as in Example 1. The results are shown in Table 3.

TABLE 3

| | | | | Low- |
|---|---|---|---|---|
| | | | Battery | temperature |
| | | Cycle | expan- | discharge |
| | | capacity | sion | capacity |
| | | retention | after | retention |
| | Positive electrode | rate | cycle | rate |
| | active material | (%) | (mm) | (%) |
| Battery 1 | LiNi_{0.80}Co_{0.15}Al_{0.05}O₂ | 88.3 | 0.24 | 75.5 |
| Battery 23 | LiNi_{1/3}Co_{1/3}Mn_{1/3}O₂ | 85.8 | 0.35 | 75.7 |
| Battery 24 | LiCoO₂ | 81.7 | 0.46 | 77.8 |
| Battery 25 | LiMn₂O₄ | 80.4 | 0.57 | 76.0 |
| Battery 26 | LiNi_{0.3}Co_{0.7}O₂ | 85.3 | 0.37 | 75.2 |
| Battery 27 | LiNi_{0.4}Co_{0.6}O₂ | 86.0 | 0.33 | 75.4 |
| Battery 28 | LiNi_{0.5}Co_{0.5}O₂ | 86.8 | 0.28 | 75.3 |
| Battery 29 | LiNi_{0.7}Co_{0.3}O₂ | 87.5 | 0.26 | 75.4 |
| Battery 30 | LiNi_{0.9}Co_{0.1}O₂ | 84.4 | 0.40 | 73.0 |
| Battery 31 | LiNi_{0.80}Co_{0.15}Mg_{0.05}O₂ | 86.7 | 0.28 | 75.5 |
| Battery 32 | LiNi_{0.80}Co_{0.15}Zn_{0.05}O₂ | 86.2 | 0.31 | 75.2 |
| Battery 33 | LiNi_{0.80}Co_{0.15}Cr_{0.05}O₂ | 85.5 | 0.35 | 75.0 |
| Battery 34 | LiNi_{0.80}Co_{0.15}Fe_{0.05}O₂ | 85.0 | 0.38 | 75.1 |
| Battery 35 | LiNi_{0.3}Mn_{0.7}O₂ | 85.0 | 0.39 | 71.4 |
| Battery 36 | LiNi_{0.5}Mn_{0.5}O₂ | 86.3 | 0.32 | 71.6 |
| Battery 37 | LiNi_{0.5}Mn_{0.4}Co_{0.1}O₂ | 86.6 | 0.30 | 72.0 |

From Table 3, the batteries using the non-aqueous electrolyte including FEC, PC, and DEC with a specific content had a favorable cycle capacity retention rate and a low-temperature discharge capacity retention rate no matter which positive electrode active material was used. Also, battery expansion after cycle was small, which indicated that the amount of gas production was small.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

According to the present invention, the decline in the charge and discharge capacity as well as in the rate characteristics at low temperatures can be suppressed even when the battery is stored in a high-temperature environment, or when the charge and discharge are repeated. Therefore, the present invention is useful as the non-aqueous electrolyte for secondary batteries for use in electronic devices such as cellular phones, personal computers, digital still cameras, game machines, and portable audio equipment.

### REFERENCE SIGNS LIST

20. Battery can
21. Electrode group
22. Positive lead
23. Negative lead
24. Insulator
25. Sealing plate
26. Insulating gasket
29. Sealing plug

1. A non-aqueous electrolyte for secondary batteries comprising a non-aqueous solvent and a lithium salt dissolved in the non-aqueous solvent,
the non-aqueous solvent including a fluorine-containing cyclic carbonate, propylene carbonate, and diethyl carbonate, and
a content W_{FCC} of the fluorine-containing cyclic carbonate being 5 to 10 mass %, a content W_{PC} of the propylene carbonate being 50 to 70 mass %, and a content W_{DEC} of the diethyl carbonate being 25 to 45 mass % relative to a total of the non-aqueous solvent.

2. (canceled)

3. The non-aqueous electrolyte for secondary batteries in accordance with claim 1, wherein the non-aqueous solvent further includes 5 mass % or less of ethylene carbonate.

4. The non-aqueous electrolyte for secondary batteries in accordance with claim 1, wherein the fluorine-containing cyclic carbonate includes fluoroethylene carbonate.

5. A non-aqueous electrolyte secondary battery comprising: a positive electrode; a negative electrode; a separator disposed between the positive electrode and the negative electrode; and the non-aqueous electrolyte for secondary batteries in accordance claim 1.

6. The non-aqueous electrolyte secondary battery in accordance with claim 5, wherein the positive electrode includes a lithium-containing transition metal oxide represented by LiₓNi_{y}M_{z}Me_{1-(y+z)}O_{2+d}, where M is at least one selected from the group consisting of Co and Mn, Me is at least one selected from the group consisting of Al, Cr, Fe, Mg, and Zn, 0.98≦x≦1.2, 0.3≦y≦1, 0≦z≦0.7, 0.9≦(y+z)≦1, and −0.01≦d≦0.01.

7. The non-aqueous electrolyte secondary battery in accordance with claim 5, wherein the negative electrode includes a negative electrode current collector and a negative electrode active material layer adhered to the negative electrode current collector, and
the negative electrode active material layer includes graphite particles and a binder binding the graphite particles.

8. The non-aqueous electrolyte secondary battery in accordance with claim 7, wherein surfaces of the graphite particles are coated with at least one water-soluble polymer selected from cellulose derivatives and polyacrylic acid.
